(19) United States
(12) Patent Application Publication
(10) Pub. No.: US 2003/0120844 A1
(43) Pub. Date: Jun. 26, 2003

(54) Digital music server and portable player

(76) Inventor: Gregory Roger Hamel, Livonia, MI (US)

Correspondence Address: BRINKS HOFER GILSON & LIONE, P.O. BOX 10395, CHICAGO, IL, 60611, US

(21) Appl. No.: 10/029,326

(22) Filed: Dec. 21, 2001

(51) Int. Cl. G06F 13/12

(52) U.S. Cl. 710/72

(57) ABSTRACT

An audio storage and reproducing apparatus is provided. The apparatus selectively operates in at least three different modes: as an addressable member of a computer network, as a portable audio player, and as an in-vehicle audio player. While in a computer network, the apparatus can function as a server for audio data files. While in the other modes of operation, the apparatus can serve as a personal audio player.

### FIELD OF THE INVENTION

The present invention relates to an audio storage and reproducing apparatus. More particularly, the present invention relates to an audio storage and reproducing apparatus that is capable of selective operation as an addressable member of a computer network, a standalone audio player, and an in-vehicle audio player. While in a computer network, the apparatus functions as a server for audio data files. While in the other modes of operation, the apparatus serves as a portable player of audio data files.

### BACKGROUND OF THE INVENTION

In recent years, the mode in which music data is stored has undergone significant change. The popularity of personal computers and the availability of inexpensive storage devices with large capacities, such as multi-gigabyte hard drives, have lead to the widespread use of various types of digital audio files.

Digital music provides several advantages over traditional forms of audio storage. Digital storage of audio files provides better sound quality and produces a richer and more enjoyable listening experience. Furthermore, digital storage of audio files allows for efficient distribution of the files among a variety of playing apparatuses. For example, an individual can listen to a popular song on his or her personal computer, then subsequently download it to a portable player for listening while away from the computer, such as while exercising.

These advantages present new complexities for the use of music and other digital audio files. For example, as indicated above, to use a digital file in more than one apparatus, an individual must move the file between those apparatuses. With prior art devices, this process typically involves connecting a first apparatus, such as a portable player, to a second apparatus, such as a personal computer, and copying the digital file between those apparatuses. This process stands in stark contrast to the relatively simple process of physically moving a cassette tape, record album, or compact disc from one player to another. This situation can become even more complex when one of the apparatuses is a personal computer on a computer network, such as a personal computer residing in a networked home. In this instance, the individual may be required to log on to his computer, access the network to find the digital file of interest, and subsequently move the file from its network location to the portable player. Depending on the portable player utilized, the individual may even be required to first move the file to his local computer prior to moving it to the portable player.

The availability of a wide variety of portable digital music players will likely ensure that digital storage of audio files becomes a standard in the future. Unfortunately, all portable players available today require the time consuming downloads mentioned above. Furthermore, the portable players available today lack additional functionality that would allow them to serve as a single source for digital music files for a consumer.

### SUMMARY OF THE INVENTION

The present invention provides a digital music apparatus that overcomes these and other disadvantages of the prior art. An apparatus according to the present invention allows an individual to enjoy the benefits of digital music without necessitating the constant copying of digital audio files between numerous playing apparatuses. Apparatuses according to the present invention accomplish this by providing for selective operation in at least three different modes. In the first mode, the apparatus functions as a server for digital audio files on a computer network. In the second mode, the apparatus functions as a portable player. Lastly, in the third mode, the apparatus functions as an in-vehicle player.

In the server mode, the apparatus functions as a server of digital audio files to all members of an attached network. For example, in a home in which three personal computers are connected to a network, the apparatus can be connected to the network such that all three computers can access the digital audio files stored on the apparatus. In this mode, the apparatus is an addressable member of the network. As a result, the apparatus provides storage of digital audio files that is accessible by all members of the network. Furthermore, digital audio files stored on the apparatus can be played locally from their network location, thereby eliminating the need for copying files from a playing apparatus to a personal computer.

As a portable player, the apparatus according to the present invention allows an individual to transport digital audio files away from the computer network. For example, the individual can remove the apparatus from the network and take the portable player outside of the home, such as when the individual goes running. In this mode, an audio output of the apparatus can include a headphone jack which allows the individual to enjoy listening to the digital audio files without disturbing others. The audio output could also include speakers which would allow the apparatus to function as a portable boom box. Importantly, the portable player functions without requiring the individual to download or copy files form his or her personal computer to the player. Rather, the individual merely takes the stored files with him or her.

In the last mode, the apparatus according to the present invention functions as an in-vehicle audio player. In this mode, the apparatus, after being removed from the computer network, connects to the audio system of the vehicle. Once connected, the apparatus is capable of outputting audio through the speakers of the vehicle audio system. As such, an individual can use the apparatus as a main or supplemental audio entertainment device in his or her vehicle.

In one embodiment, an apparatus according to the present invention comprises a storage medium for storing one or more encoded audio data files, a data expander coupled to the storage medium for decoding the audio files, a controller coupled to the data expander, an audio output, a personal computer network interface, and a personal computer bus. The audio output is adapted to produce audio corresponding to an encoded audio data file that has been decoded by the data expander. The network interface allows transfer of encoded audio files from the storage medium to an external storage device, such as a hard drive of another computer on a connected computer network. Lastly, the personal computer bus allows the apparatus to transmit audio data files from the storage medium to the data expander and the audio output, or from the storage medium to the network interface.

While the invention is defined by the claims appended hereto, additional understanding of the invention can be gained from the following detailed description of a preferred embodiment and the referenced figures.

### BRIEF DESCRIPTION OF THE DRAWINGS

FIG. 1 is a perspective view of an apparatus according to a first preferred embodiment of the present invention.

FIG. 2 is a block diagram illustrating various operative components of the apparatus shown in FIG. 1.

FIG. 3 is a perspective view of the apparatus shown in FIG. 1. In this view, the apparatus is functioning in an alternative operating mode.

FIG. 4 is a perspective view of the apparatus shown in FIG. 1. In this view, the apparatus is shown operating in a further alternative operating mode.

### DETAILED DESCRIPTION OF THE PREFERRED EMBODIMENT OF THE INVENTION

The following description of a preferred embodiment of the invention provides an example of the present invention. The embodiment discussed herein is merely exemplary in nature, and is not intended to limit the scope of the invention in any manner. Rather, the description of the preferred embodiment serves to enable a person of ordinary skill in the relevant art to make and use the present invention.

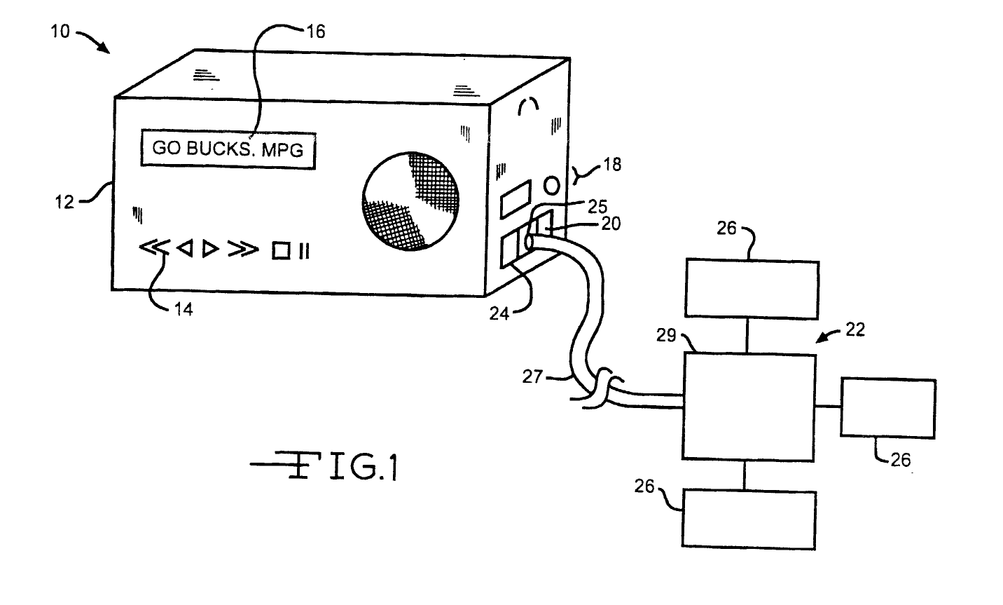

FIG. 1 illustrates an audio storage and reproducing apparatus 10 according to a preferred embodiment of the present invention. The apparatus 10 includes a housing unit 12, various input keys 14 for controlling the operation of the apparatus 10, a display 16 for conveying visual information to an individual regarding the status of the apparatus 10, an audio output 18 for transmitting audible information to an individual, and a network interface 20 for connecting to a computer network 22.

The input keys 14 provide a mechanism by which an individual can control the operation of the apparatus 10. As such, the input keys 14 preferably comprise a group of independent buttons that correspond to standard playback functions typically used in audio equipment. Examples of such buttons include a play button, a fast forward button, a rewind button, a stop button, and a pause button. In contrast to a cassette player, however, the input keys 14 control digital functions. As such, activation of one of the keys 14 induces the apparatus 10 to take an appropriate action on an audio data file stored within the apparatus 10.

The display 16 provides a mechanism by which the apparatus 10 can convey visual information to an individual. For example, as illustrated in FIG. 1, the apparatus 10 can indicate the name of the current audio data file being played through the audio output 18. The display 16 can be any suitable display device known to those skilled in the art. A particularly preferred type of display is an LCD screen.

The audio output 18 provides the mechanism by which the apparatus 10 communicates audible information, which corresponds to audio data files stored on the apparatus 10, to an individual. Accordingly, the audio output is adapted to produce audio that corresponds to an encoded audio data file that has been decoded by a component of the apparatus 10, such as a data expander (discussed in detail below). To achieve this, various types of audio outputs known to those skilled in the art can be utilized. Examples of suitable audio outputs include headphone jacks, infrared transmitters (for sending data to infrared enabled audio devices), one or more speakers incorporated into the apparatus 10, and a set of detachable speakers. Preferably, in accordance with the ability of the apparatus 10 to selectively operate in several different operating modes, the audio output 18 includes a variety of different devices, such as a combination of a headphone jack and detachable speakers.

The network interface 20 provides the interface by which the apparatus 10 connects to a computer network 22. Accordingly, the network interface 20 can comprise any suitable interface for connecting a component to such a network. Examples of acceptable network interfaces include interfaces for Apple Talk Networks, UNIX Networks, and Windows Networks. Preferably, the network interface 20 enables an Ethernet connection between the apparatus 10 and the computer network 22. The interface 20 will typically include a network interface card 24 with appropriate electronics and chip sets, and a jack 25 for receiving a network cable 27. Preferably, the network interface card 24 includes a jack 25 that allows the use of standard networking cables, such as an RJ 45 jack that receives CAT 5E cabling, which is typically used for Ethernet networks. Alternatively, other suitable cabling and jacks can be used. Also alternatively, wireless networking can be utilized.

The computer network 22 preferably includes one or more personal computer workstations 26 centrally connected to a network hub or switch 29. The apparatus 10 is likewise connected to the hub or switch 29 by way of the network interface 20. This central connection design allows the apparatus 10 to efficiently function as a server on the network 22. In this operational mode, the audio data files stored on the apparatus 10 can be accessed by any of the workstations 26 connected to the network 22. Preferably, the apparatus 10 is connected to the network 22 in such a manner that it is an addressable member of the network 22. That is, the network connection is preferably such that the apparatus 10 appears as a named entity on the workstations 26 connected to the network 22. This arrangement allows for an individual using one of the workstations 26 to easily utilize the audio data files stored on the apparatus 10. For example, by selecting the apparatus 10 in a file management utility on a workstation 26, an individual can either play audio data files locally through his or her workstation 26, or can move the files from the apparatus 10 to a storage device located on the workstation 26 (i.e., a storage device external to any storage medium of the apparatus 10).

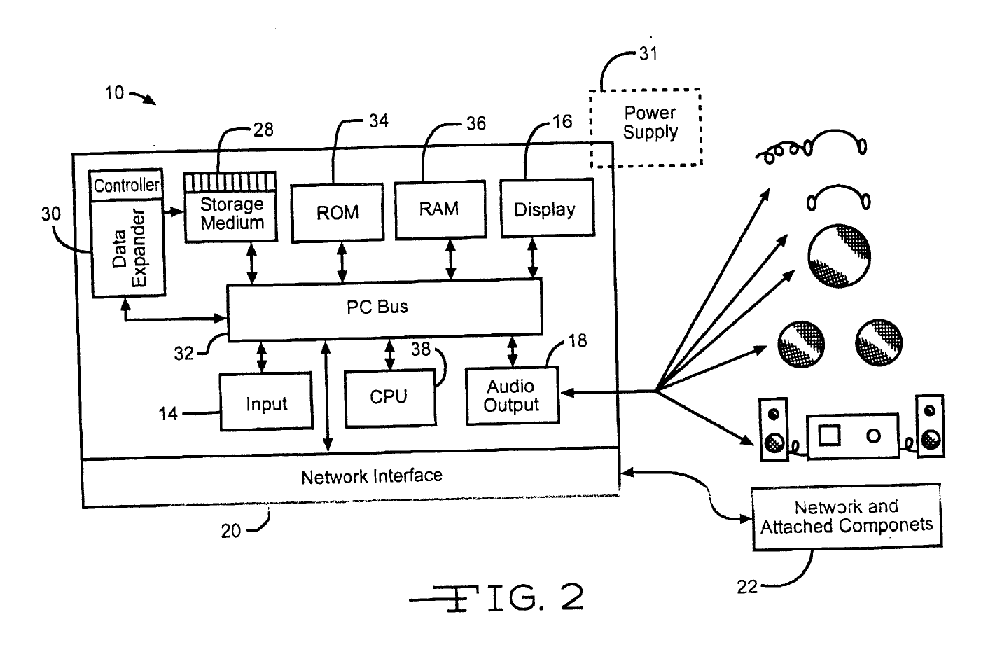

FIG. 2 presents a block diagram that illustrates various operative components of the apparatus 10. As illustrated in the Figure, the apparatus 10 preferably further comprises appropriate computing components, such as Read Only Memory (ROM) 34, Random Access Memory 36, and a central processing unit (CPU) 38.

Also, a data expansion unit (a data expander) 30 is operably connected to the storage medium 28. The data expander 30 is an expansion unit capable of decoding encoded audio data files. Such expansion units are known to those skilled in the art and will not be described in detail herein. For background information on suitable data expansion units, see generally U.S. Pat. No. 6,076,063 to Unno et al., for an AUDIO PLAYER AND RECORDER EMPLOYING SEMICONDUCTOR MEMORY AS A RECORDING MEDIUM. Preferably, the data expander 30 is capable of decoding various forms of compressed audio data known to those skilled in the art. Particularly preferably, the data expander 30 is at least capable of decoding MP3 files (Motion Picture Experts Group Layer Three).

A PC Bus 32, such as a standard PC ISA (Industry Standard Architecture) or PCI (Peripheral Computer Interconnect) bus, provides the communications backbone of the apparatus. As illustrated in FIG. 2, the bus 32 allows for transmission of data from the storage medium 28 to the data expander 30 and the audio output or from the storage medium 28 to the network interface 20.

The ROM 34, RAM 36, and CPU are also operably connected to the bus 32.

A power supply 31 is illustrated as partially in and partially out of the apparatus 10 to illustrate the various types of power supplies that can be used. Internal sources, such as rechargeable batteries, as well as external sources, such as a home electrical supply or a vehicle electrical supply, can be used as the power supply 31. Preferably, in accordance with the multi-mode operation of the apparatus 10, a combination of power supplies is utilized. For example, when the apparatus is utilized as a portable player, the power supply 31 preferably comprises a rechargeable battery. However, when the apparatus 10 is utilized in the server or vehicle modes, the power supply 31 preferably comprises a connection to a home or vehicle electrical supply, respectively.

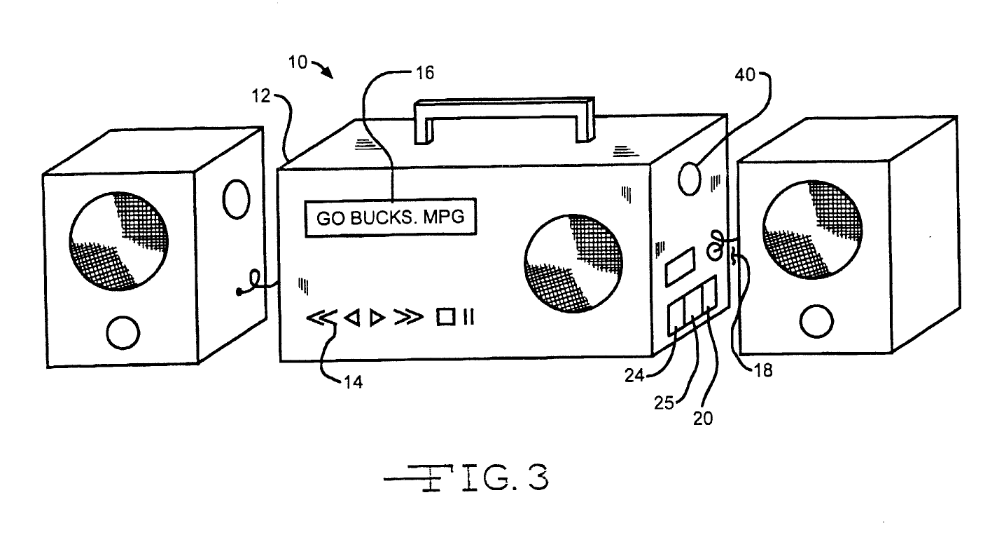

FIG. 3 illustrates the apparatus 10 being used as a portable player. In this mode of operation, the apparatus 10 has been disconnected from the computer network 22. The apparatus 10 can output audio through, for example, speakers. To allow greater functionality, the housing 12 can define one or more clips 40 that allow for detachment of the speakers. These clips allow an individual to quickly detach the speakers and spread them out in a space, such as in a large room.

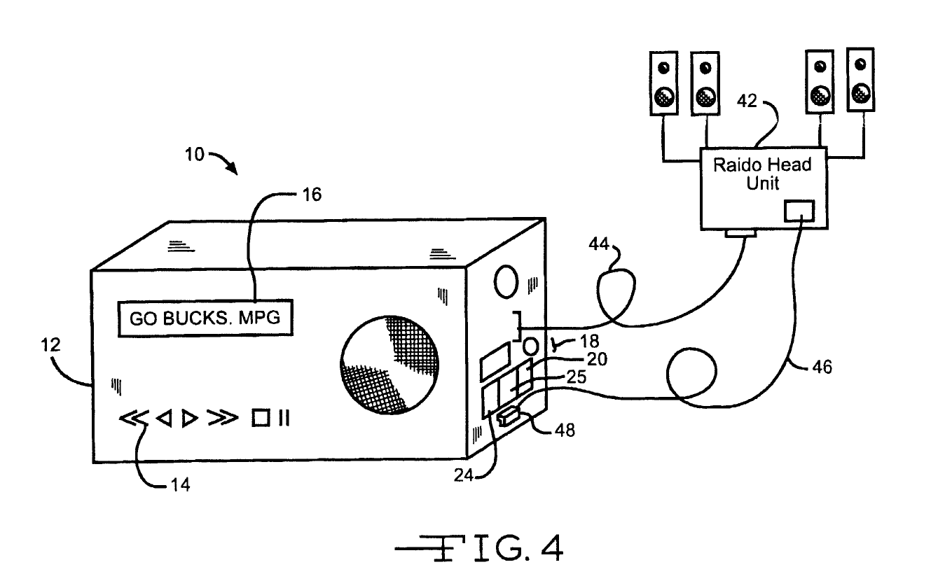

FIG. 4 illustrates the apparatus being used as an in-vehicle audio player. In this mode of operation, the apparatus 10 is operably connected to the radio head unit 42 of the vehicle such that the audio output of the apparatus 10 is connected to the speakers of the vehicle radio 42. Preferably, a standard audio cable 44 provides the audio connection. Also, a control cable 46 can be utilized to connect the controls of the vehicle radio 42 to the apparatus 10 such that an individual can control operation of the apparatus 10 by using the controls of the vehicle radio 42.

Preferably, a quick-release connection is utilized in the vehicle. This allows an individual to rapidly connect and disconnect the apparatus 10 to the vehicle radio 42, which will greatly facilitate use of the apparatus 10. Accordingly, the housing 12 of the apparatus preferably includes one or more quick-release fasteners 48. These fasteners 48 can interact with fasteners or other structural features of the vehicle to enable the desired quick-release connection.

Also, the operable connection between the apparatus 10 and vehicle radio head unit 42 is preferably a quick-release connection. This can be accomplished by using conventional pigtail or drop-in type electrical connections for the audio 44 and control 46 connections.

The foregoing disclosure includes the best mode devised by the inventor for practicing the invention. It is apparent, however, that several variations in accordance with the present invention may be conceivable to one of ordinary skill in the relevant art. Inasmuch as the foregoing disclosure is intended to enable such person to practice the instant invention, it should not be construed to be limited thereby, but should be construed to include such aforementioned variations. As such, the present invention should be limited only by the spirit and scope of the following claims.

1. An audio storage and reproducing apparatus, comprising:
a storage medium for storing one or more encoded audio data files;
a data expander coupled to the storage medium for decoding the one or more encoded audio data files;
an audio output adapted to produce audio corresponding to an encoded audio data file that has been decoded by the data expander;
a personal computer network interface adapted to facilitate transfer of encoded audio files to an external storage device; and
a personal computer bus for transmitting data from the storage medium to the data expander and the audio output or from the storage medium to the network interface.

2. An audio storage and reproducing apparatus as in claim 1, wherein the storage medium comprises a hard disk drive.

3. An audio storage and reproducing apparatus as in claim 1, wherein the storage medium comprises a flash memory device.

4. An audio storage and reproducing apparatus as in claim 1, wherein the audio output includes one or more speakers.

5. An audio storage and reproducing apparatus as in claim 4, further comprising an amplifier to process an encoded audio data file that has been decoded by the data expander for transmission through the audio output.

6. An audio storage and reproducing apparatus as in claim 4, wherein the one or more speakers can be selectively detached from said apparatus.

7. An audio storage and reproducing apparatus as in claim 6, wherein the audio output further includes a terminal that is exposed upon detachment of the one or more speakers and that is adapted to be coupled to an audio input of a vehicle audio system.

8. An audio storage and reproducing apparatus as in claim 1, wherein the audio output is adapted to be coupled to an audio input of a vehicle audio system.

9. An audio storage and reproducing apparatus as in claim 1, wherein the personal computer network interface includes an Ethernet port.

10. An audio storage and reproducing apparatus as in claim 1, further comprising one or more fasteners adapted to cooperate with structural members of a vehicle audio system to allow rapid connection and disconnection of said apparatus to the vehicle audio system.

11. An audio storage and reproducing apparatus, comprising:
storage means for storing one or more encoded audio data files;
data expansion means coupled to the storage means for decoding the one or more encoded audio data files;
audio output means for producing audio corresponding to an encoded audio data file that has been decoded by the data expansion means;
a personal computer network interface adapted to facilitate transfer of encoded audio files from the storage means to an external storage device; and
a personal computer bus for transmitting data from the storage means to the data expansion means and the audio output means or from the storage means to the network interface.

12. An audio storage and reproducing apparatus as in claim 11, wherein the audio output means includes one or more speakers.

13. An audio storage and reproducing apparatus as in claim 12, further comprising an amplifier to process an encoded audio data file that has been decoded by the data expander for transmission through the audio output means.

14. An audio storage and reproducing apparatus as in claim 11, wherein the audio output means are adapted to be coupled to audio input means of a vehicle audio system.

15. An audio storage and reproducing apparatus capable of selective operation as an addressable member of a computer network, a standalone audio player, and an in-vehicle audio player, said apparatus comprising:
a storage medium for storing one or more encoded audio data files;
a data expander coupled to the storage medium for decoding the one or more encoded audio data files;
an input key operably connected to the data expander;
an audio output adapted to produce audio corresponding to an encoded audio data file that has been decoded by the data expander;
a network protocol adapted to allow other members of said network to access the storage medium when said apparatus is operating as an addressable member of a computer network;
a network interface adapted to operably connect said apparatus to said network; and
one or more fasteners adapted to cooperate with structural members of a vehicle audio system to allow rapid connection and disconnection of said apparatus to the vehicle operating system.

16. An audio storage and reproducing apparatus as in claim 15, wherein the storage medium comprises a hard disk drive.

17. An audio storage and reproducing apparatus as in claim 15, wherein the storage medium comprises a flash memory device.

18. An audio storage and reproducing apparatus as in claim 15, wherein the audio output includes one or more speakers, a headphone jack, and a connector for coupling the audio output to an audio input of a vehicle audio system.

19. An audio storage and reproducing apparatus as in claim 18, wherein the one or more speakers can be selectively detached from said apparatus.

20. An audio storage and reproducing apparatus as in claim 18, further comprising a rechargeable power supply.
